(19) United States
(12) Patent Application Publication
(10) Pub. No.: US 2016/0337928 A1
(43) Pub. Date: Nov. 17, 2016

(54) MEASUREMENT REPORTING FOR CIRCUIT SWITCHED FALL BACK SERVICES

(71) Applicant: QUALCOMM Incorporated, San Diego, CA (US)

(72) Inventors: Ming YANG, San Diego, CA (US); Tom CHIN, San Diego, CA (US); Shaohong QU, San Diego, CA (US)

(21) Appl. No.: 14/714,181

(22) Filed: May 15, 2015

(51) Int. Cl. H04W 36/30; H04L 12/26

(52) U.S. Cl. CPC H04W 36/30; H04L 43/06

(57) ABSTRACT

A method of wireless communication at a user equipment (UE) includes initiating a procedure for a circuit switched fall back (CSFB) service in response to a mobile originated voice call or a mobile terminated voice call in a radio access technology (RAT) not supporting circuit switched voice calls. The method further includes determining whether a time to trigger (TTT) timer has expired for a measurement report configured to trigger a handover to a target cell. The method also includes determining whether the target cell is of a RAT supporting circuit-switched voice calls. If so, sending of the measurement report is delayed, i.e., when the RAT of the target cell does not support circuit-switched voice calls.

### BACKGROUND

1. Field

Aspects of the present disclosure relate generally to wireless communication systems, and more particularly, to improved measurement reporting for circuit switched fall back (CSFB) services.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is long term evolution (LTE). LTE is a set of enhancements to the universal mobile telecommunications system (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### SUMMARY

In an aspect of the present disclosure, a method of wireless communication at a user equipment (UE) is presented. The method includes initiating a procedure for a circuit switched fall back (CSFB) service in response to a mobile originated voice call or a mobile terminated voice call in a radio access technology (RAT) not supporting circuit switched voice calls. The method further includes determining whether a time to trigger (TTT) timer has expired for a measurement report configured to trigger a handover to a target cell. The method also includes determining whether the target cell is of a RAT supporting circuit-switched voice calls, and delaying sending of the measurement report when the RAT of the target cell does not support circuit-switched voice calls.

In another aspect of the present disclosure, an apparatus for wireless communication includes a memory and at least one processor coupled to the memory. The processor(s) is configured to initiate a procedure for a circuit switched fall back (CSFB) service in response to a mobile originated voice call or a mobile terminated voice call in a radio access technology (RAT) not supporting circuit switched voice calls. The processor(s) is further configured to determine whether a time to trigger (TTT) timer has expired for a measurement report configured to trigger a handover to a target cell. The processor(s) is also configured to determine whether the target cell is of a RAT supporting circuit-switched voice calls and to delay sending of the measurement report when the RAT of the target cell does not support circuit-switched voice calls.

In yet another aspect of the present disclosure, an apparatus for wireless communication includes means for initiating a procedure for a circuit switched fall back (CSFB) service in response to a mobile originated voice call or a mobile terminated voice call in a radio access technology (RAT) not supporting circuit switched voice calls. The apparatus further includes means for determining whether a time to trigger (TTT) timer has expired for a measurement report configured to trigger a handover to a target cell. The apparatus also includes means for determining whether the target cell is of a RAT supporting circuit-switched voice calls, and means for delaying sending of the measurement report when the RAT of the target cell does not support circuit-switched voice calls.

In still another aspect of the present disclosure, a computer program product for wireless communication includes a non-transitory computer readable medium having encoded thereon program code. The program code includes program code to initiate a procedure for a circuit switched fall back (CSFB) service in response to a mobile originated voice call or a mobile terminated voice call in a radio access technology (RAT) not supporting circuit switched voice calls. The program code further includes program code to determine whether a time to trigger (TTT) timer has expired for a measurement report configured to trigger a handover to a target cell. The program code also includes program code to determine whether the target cell is of a RAT supporting circuit-switched voice calls, and program code to delay sending of the measurement report when the RAT of the target cell does not support circuit-switched voice calls.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 illustrates network coverage areas according to aspects of the present disclosure.

FIG. 5 is a flow diagram conceptually illustrating an example process for optimized measurement reporting for CSFB services according to one aspect of the present disclosure.

FIG. 6 is a flow diagram illustrating an example decision process for optimized measurement reporting for CSFB services according to one aspect of the present disclosure.

FIG. 7 is a flow diagram illustrating a method for optimized measurement reporting for CSFB services at a UE according to one aspect of the present disclosure.

FIG. 8 is a block diagram illustrating different modules/means/components for optimized measurement reporting for CSFB services in an example apparatus according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

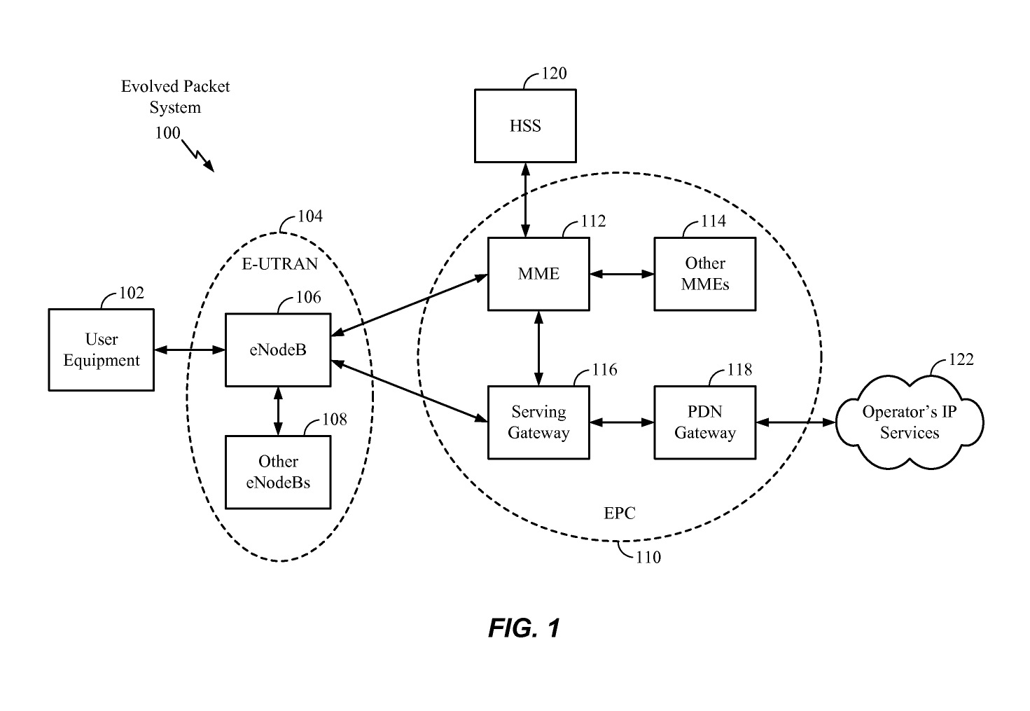

FIG. 1 is a diagram illustrating an LTE network architecture 100. The LTE network architecture 100 may be referred to as an evolved packet system (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity those entities/interfaces are not shown. As shown, the EPS 100 provides packet-switched services, however, as those skilled in the art will readily appreciate, the various concepts presented throughout this disclosure may be extended to networks providing circuit-switched services.

The E-UTRAN 104 includes an evolved Node B (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an S1 interface. The EPC 110 includes a mobility management entity (MME) 112, other MMEs 114, a serving gateway 116, and a packet data network (PDN) gateway 118. The MME 112 is the control node that processes the signaling between the UE 102 and the EPC 110. Generally, the MME 112 provides bearer and connection management. All user IP packets are transferred through the serving gateway 116, which itself is connected to the PDN gateway 118. The PDN gateway 118 provides UE IP address allocation as well as other functions. The PDN gateway 118 is connected to the operator's IP services 122. The operator's IP services 122 may include the Internet, the Intranet, an IP multimedia subsystem (IMS), and a PS streaming service (PSS).

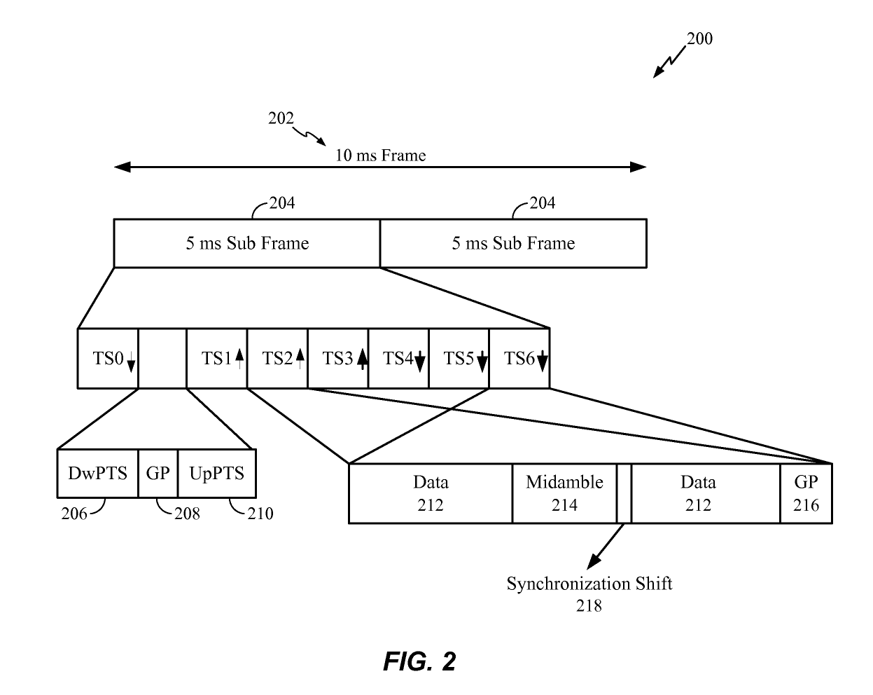

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. Synchronization shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

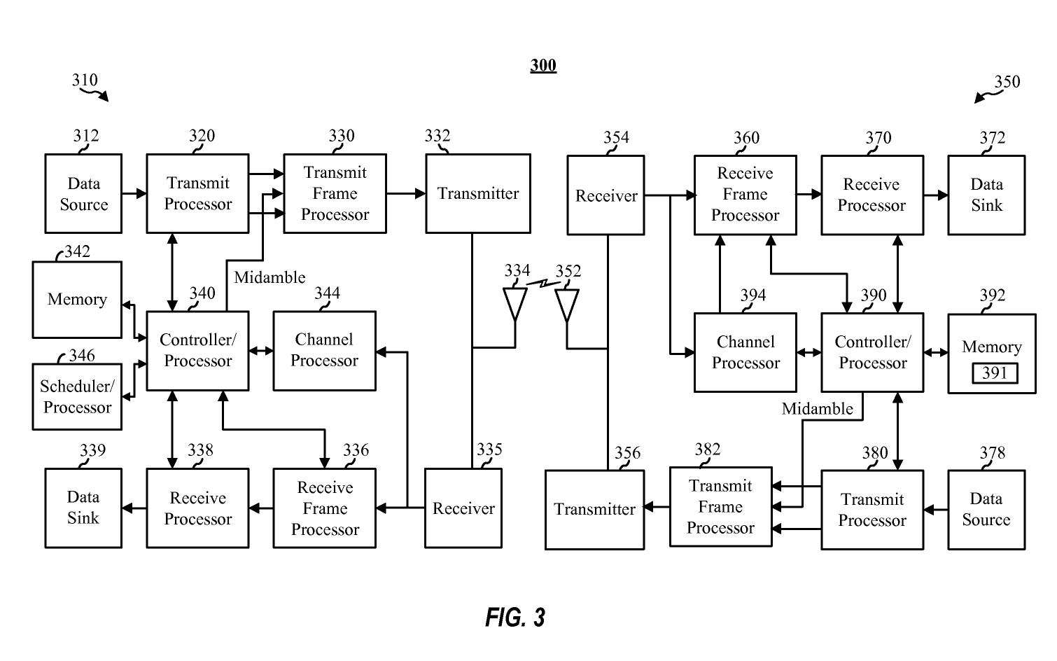

FIG. 3 is a block diagram of a node B 310 in communication with a UE 350 in a RAN 300, where the RAN 300 may be the E-UTRAN 104 in FIG. 1 or a TD-SCDMA RAN, the node B 310 may be the LTE eNodeB 106 in FIG. 1 or a TD-SCDMA node B, and the UE 350 may be the UE 102 (which can operate in multiple RANs) in FIG. 1. In the downlink communication, a transmit processor 320 may receive data from a data source 312 and control signals from a controller/processor 340.

The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 of FIG. 2 from the UE 350. The symbols generated by the transmit processor 320 are provided to a transmit frame processor 330 to create a frame structure. The transmit frame processor 330 creates this frame structure by multiplexing the symbols with a midamble 214 of FIG. 2 from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 of FIG. 2 to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 of FIG. 2 from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 of FIG. 2 to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames. Additionally, a scheduler/processor 346 at the node B 310 may be used to allocate resources to the UEs and schedule downlink and/or uplink transmissions for the UEs.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store a measurement reporting module 391 which, when executed by the controller/processor 390, may configure the UE 350 for improving measurement reporting for CSFB services, such as for a voice call.

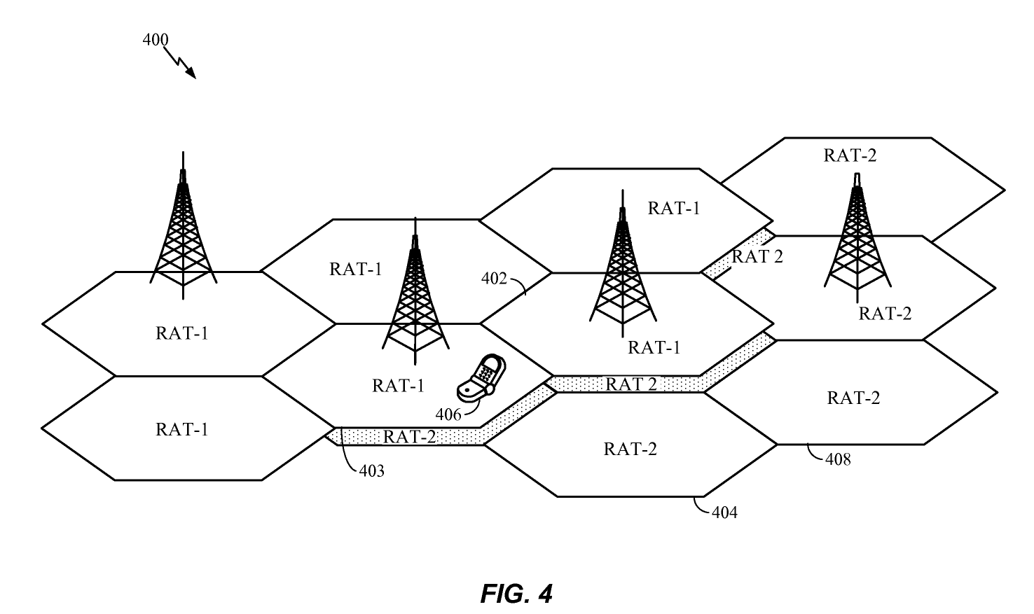

FIG. 4 illustrates sample network coverage areas according to aspects of the present disclosure. Some networks, such as a newly deployed network, may cover only a portion of a geographical area. Another network, such as an older more established network, may better cover the area, including remaining portions of the geographical area. FIG. 4 illustrates coverage of a newly deployed network utilizing a first type of radio access technology (RAT-1), such as an LTE, a TD-LTE, or TD-SCDMA network, etc. FIG. 4 also illustrates a more established network utilizing a second type of radio access technology (RAT-2), such as GSM, or CDMA network, etc.

The geographical area 400 may include RAT-1 cells 402 and 403 and RAT-2 cells 404 and 408. In one example, the RAT-1 cells 402 and 403 may not support voice calls. The RAT-2 cell 404, such as a 2G/3G RAT cell (e.g., GSM, TD-SCDMA, etc.), may support circuit-switched fall back (CSFB) service such as a voice call. In another example, the other RAT-2 cell 408, such as a GSM or TD-SCDMA network may not support a CSFB services such as a voice call for a specific RAT. However, those skilled in the art will appreciate that other types of radio access technologies may be utilized within the cells. The user equipment (UE) 406 may move from one cell, such as the RAT-1 cell 403, to another cell, such as the other RAT-1 cell 402. The movement of the UE 406 may involve a handover or a cell reselection procedure.

In another example, the UE 406 may trigger a handover by redirecting to a RAT-2 cell such as the RAT-2 cell 404 for a CSFB service such as a voice call. For example, while under the coverage of the serving RAT-1 cell 403, the UE 406 may originate a voice call or receive a mobile terminated call. It so happens that the RAT-1 cell 403 does not support a voice call. Therefore the UE 406 is redirected to a target RAT-2 cell that supports the voice call. A handover or cell reselection may be performed when the UE 406 is redirected to the RAT-2 cell 404.

In one aspect of the present disclosure, before the UE 406 is redirected to the RAT-2 cell 404, the serving RAT-1 cell 403 may send a connection release message. Included in the release message may be a target RAT-2 cell. The target RAT-2 cell may or may not support CSFB services such as a voice call of a specific RAT. Thus, the UE 406 may need to perform a check to determine that the target RAT-2 cell 404 is the RAT supporting the CSFB service, before initiating a random access procedure to connect to the target RAT-2 cell 404.

A handover or cell reselection may also be performed when there is a coverage hole or lack of coverage in one network or when there is traffic balancing between first RAT and the second RAT networks. As part of that handover or cell reselection process, while in a connected mode with a RAT-1 system (e.g., TD-LTE) a UE may be specified to perform a measurement of a neighboring cell (such as a GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell such as the RAT-1 cell 403 a measurement report indicating results of the IRAT measurement performed by the UE 406. The serving cell may then trigger a handover of the UE 406 to a new cell in the other RAT, such as the RAT-2 cell 404, based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

### Measurement Reporting for CSFB Services

Circuit switched fall back (CSFB) is a feature that enables multimode UEs that are capable of 2G/3G communication, in addition to LTE, to obtain circuit-switched services while camped on LTE. A CSFB capable UE may initiate a mobile originated circuit switched voice call while camped on LTE, resulting in the UE being redirected to a circuit switched RAT, such as 2G or 3G, for voice call setup. Similarly, a CSFB capable UE may be paged for a mobile terminated voice call while camped on LTE, resulting in the UE being redirected to a circuit switched RAT for the voice call. Circuit switched fall back latency is an important issue. Longer CSFB latency negatively impacts user perception.

Beyond circuit switched fall back, other types of redirection services redirect a UE from one RAT to another RAT, such as for load balancing and other features. Example of the RATs that the UE is redirected to may include universal mobile telecommunications system (UMTS) frequency division duplex (FDD), UMTS TDD (time division duplex), and global system for mobile communications (GSM).

While in connected mode in a packet switched network, a user may initiate a voice call or receive circuit-switched paging. Accordingly, a circuit switched fall back procedure may start. In some cases, the UE may initiate a handover procedure during the CSFB procedure by sending a measurement report. For example, radio conditions may have sufficiently degraded such that the UE initiates the handover. This handover may be initiated before receiving a CSFB radio resource control (RRC) connection release message with a redirection command.

If a time to trigger (TTT) timer expires for the measurement report, which initiates handover to a target cell, the UE sends the measurement report regardless of the information in the CSFB release message. The associated LTE eNode B then sends a handover command to the UE, and in response, the UE initiates a handover to the target cell.

If the target cell is not in a target RAT list for the circuit-switched fall back service associated with the connection release message, this process not only may delay the CSFB call setup, but sometimes may cause a CSFB setup failure. For example, the handover procedure may fail. Even if the handover procedure is successful, if the target cell is not of a RAT that supports CSFB services, a CSFB setup failure may occur.

To address these issues, according to the present disclosure, additional processing occurs when the TTT timer associated with the measurement report expires. If a target cell (associated with the measurement report and TTT timer) to be reported is not of a RAT supporting the CSFB service, the UE may delay sending the measurement report. Consequently, a handover to a non-CSFB cell is not initiated immediately. The UE also may suspend various measurements for the target cell. Suspending measurements and delaying measurement reporting together reduce the latency in CSFB call setup and also conserve UE battery power.

While the measurements and reporting are delayed, the UE can attempt to acquire any cells in the redirection list of the release message. The UE then performs circuit switched fall back to one of these cells, if possible, rather than handing over to a non-CSFB cell.

The UE may determine whether the target cell supports CSFB services, based on public land mobile network (PLMN) IDs and/or a CSFB history. For example, the CSFB history may indicate that a particular 2G network is preferred for CSFB service for a particular carrier (i.e., PLMN ID). Thus, a measurement report for another network, such as a 3G network, may be delayed for this particular carrier. The network ID (i.e., PLMN ID) may be obtained from system information messages.

If the target cell supports CSFB services, the UE may immediately send the measurement report after the TTT timer expires. After the UE hands over to the target cell, the UE can proceed to the CSFB call setup with the target cell.

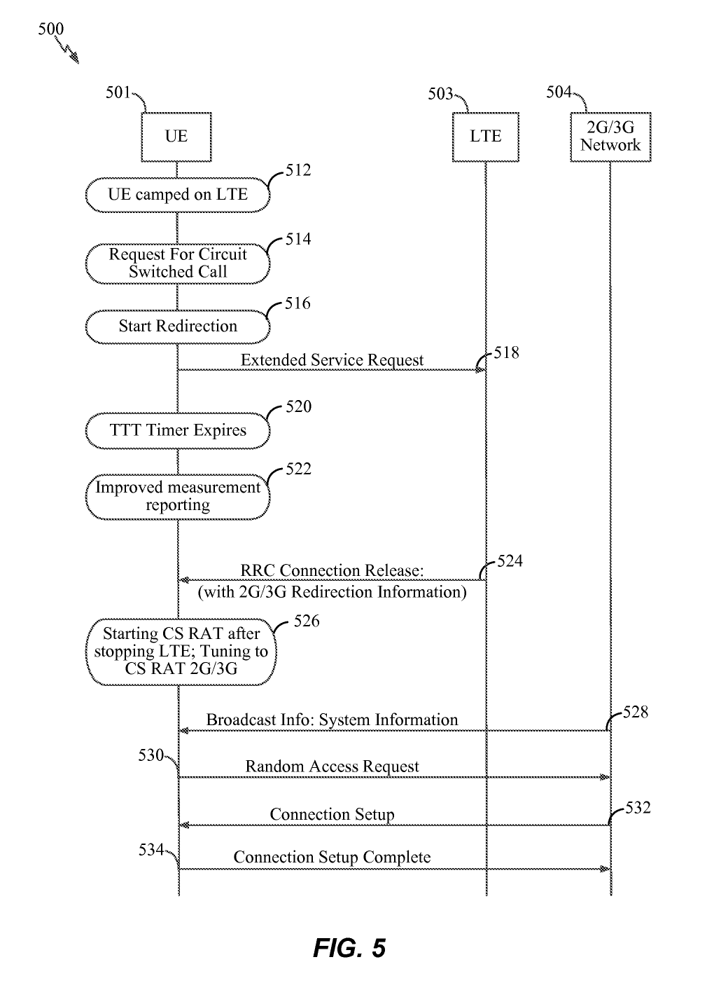

FIG. 5 shows a flow diagram 500 conceptually illustrating an example process for improving measurement reporting for CSFB services according to aspects of the present disclosure.

In one example, the UE 501 is a multimode, CSFB-capable UE supporting 2G/3G and LTE communications. The UE may use the CSFB feature for circuit switched (CS) voice services while camped on an LTE network 503. The CSFB-capable UE 501 may initiate a mobile originated (MO) voice call while on the LTE network 503, resulting in the UE 501 moving to a CS capable 2G/3G network 504. In another example, the CSFB-capable UE 501 may be paged for a mobile-terminated (MT) voice call while camped on the LTE network 503, also resulting in the UE 501 moving to the 2G/3G network 504 for circuit switched voice call setup.

In one example, the UE 501 at time 512 is camped on the LTE network 503. At time 514, the UE 501 initiates a mobile originated circuit switched voice call or receives a circuit switched page, causing the UE 501 to begin a redirection service, such as circuit switched fall back, at time 516. Consequently, the UE sends an extended service request, at time 518, to initiate the CSFB service.

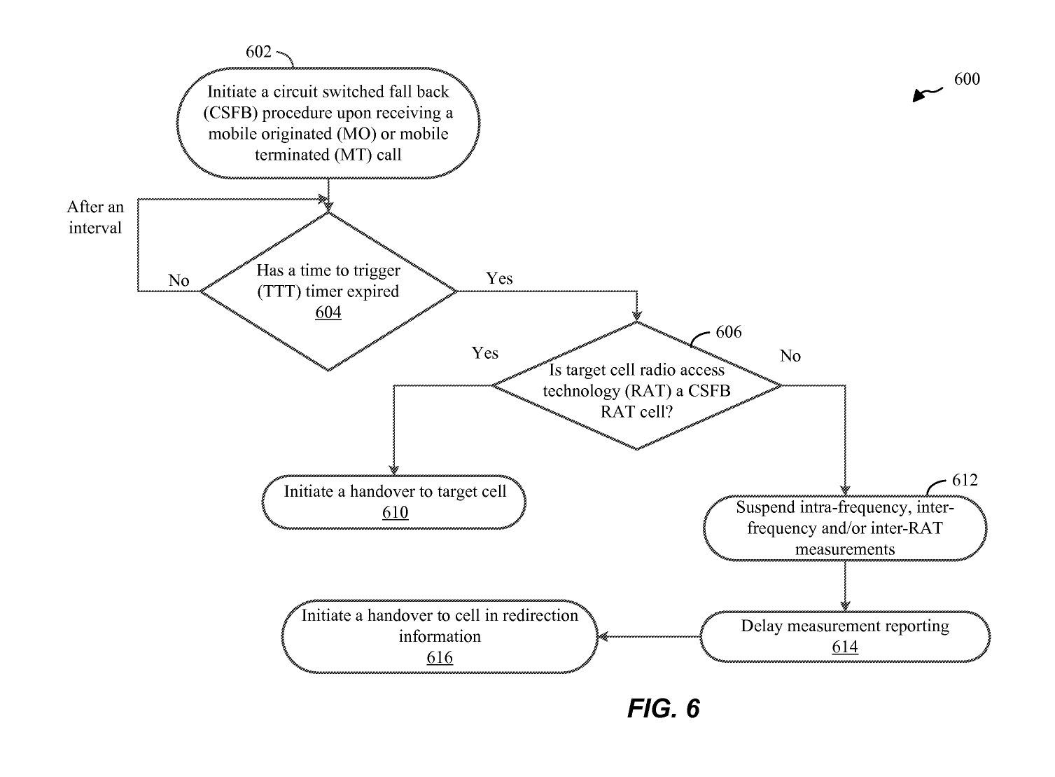

Radio conditions may change after the CSFB service was started, causing the UE to initiate a time to trigger (TTT) timer. For example, a signal quality of a serving cell may fall below a predetermined threshold while a neighbor cell signal quality exceeds a predetermined threshold. Once the TTT timer expires at time 520, the UE would usually send a measurement report for this neighbor cell. However, according to aspects of the present disclosure, at time 522, the UE performs improved measurement reporting to reduce potential delay in CSFB call setup and to reduce the chance for a potential CSFB call setup failure. More specifically, the UE 501 checks to determine if the neighbor cell is of a RAT supporting the circuit switched fall back service before sending the measurement report. If the neighbor cell does not support CSFB, the UE 501 may suspend an intra-frequency measurement, an inter-frequency measurement and/or an inter-RAT measurement, and delay reporting of the measurements, as explained in more detail with reference to FIG. 6.

Returning to the CSFB process, at time 524, the LTE network 503 sends a radio resource control (RRC) connection release message. The message includes 2G/3G redirection information to initiate a redirection to the CSFB-capable 2G/3G network 504.

Depending on the outcome of the improved measurement reporting analysis, the UE then begins redirection to either the neighbor cell associated with the measurement report or to a cell listed in the connection release message. At time 526, the UE 501 may stop LTE RAT related activities and start handing over to the 2G/3G network 504. Also at time 526 as part of redirection to the 2G/3G network 504, the UE 501 tunes to the 2G/3G network 504 to acquire information about the 2G/3G RAT. At time 528, the 2G/3G network 504 broadcasts its system information messages on a 2G/3G RAT broadcast channel.

At time 530, after receiving the system information, the UE 501 may begin a random access process by sending a random access request to the 2G/3G network 504. In response, at time 532, the 2G/3G network 504 may send a connection setup message to allow the UE 501 to proceed with the connection setup for the circuit switched voice call. At time 534, the UE 501 sends a connection setup complete message to indicate that the connection has been established with the 2G/3G network 504 for the voice call, completing the CSFB procedure.

FIG. 6 shows a flow diagram 600 illustrating, as an example, a decision process for improving measurement reporting for redirection services at a UE according to aspects of the present disclosure. The flow diagram 600 is for illustration purposes only and other alternative aspects of the decision process for improving measurement reporting are possible.

At block 602, the UE initiates a redirection (e.g., CSFB) procedure for a voice call upon receiving a mobile originated or mobile terminated call. The UE and the 2G/3G network of FIG. 6 may be the UE 501, and the 2G/3G network 504 of FIG. 5, respectively. As part of initiating the CSFB procedure for a voice call, the UE sends an extended service request (ESR) message to the serving base station, such as an LTE eNodeB, and receives an RRC release message.

Unrelated to the CSFB process, the UE initiates a time to trigger (TTT) timer in response to some criteria. For example, a serving cell signal quality may have fallen below a predetermined threshold and/or a neighbor cell signal quality may be above a predetermined threshold. The UE at decision block 604 determines whether the time to trigger (TTT) timer has expired. If no, the UE waits for a predetermined interval before checking again.

If the timer has expired, the UE, at decision block 606, instead of blindly handing over to the neighbor cell associated with the TTT timer (e.g., sending a measurement report for the target neighbor cell), further determines whether the target neighbor cell supports CSFB (e.g., is of a CSFB RAT). If yes, at block 610, the UE initiates a handover to the target cell.

The target neighbor cell RAT may not be a CSFB RAT, meaning that the target cell RAT does not support the voice service (or is not preferred by the carrier for CSFB service). In one aspect of the present disclosure, the UE at block 612 may suspend one or more of an inter-frequency measurement, an intra-frequency measurement, and an inter-RAT frequency measurement, depending on a measurement report configuration at the UE. Then at block 614, the UE delays the measurement reporting to the serving cell, e.g. of the LTE network 503 of FIG. 5. This would at least delay triggering a handover to the target cell that is not the RAT supporting CSFB services, reduce potential delay in CSFB call setup, and conserve battery power by not performing unnecessary measurements and measurement reporting. At block 616, the UE hands over to a target cell from the redirection information in the CSFB connection release message. Once handed over to the target cell, the UE establishes a connection to complete the CSFB procedure.

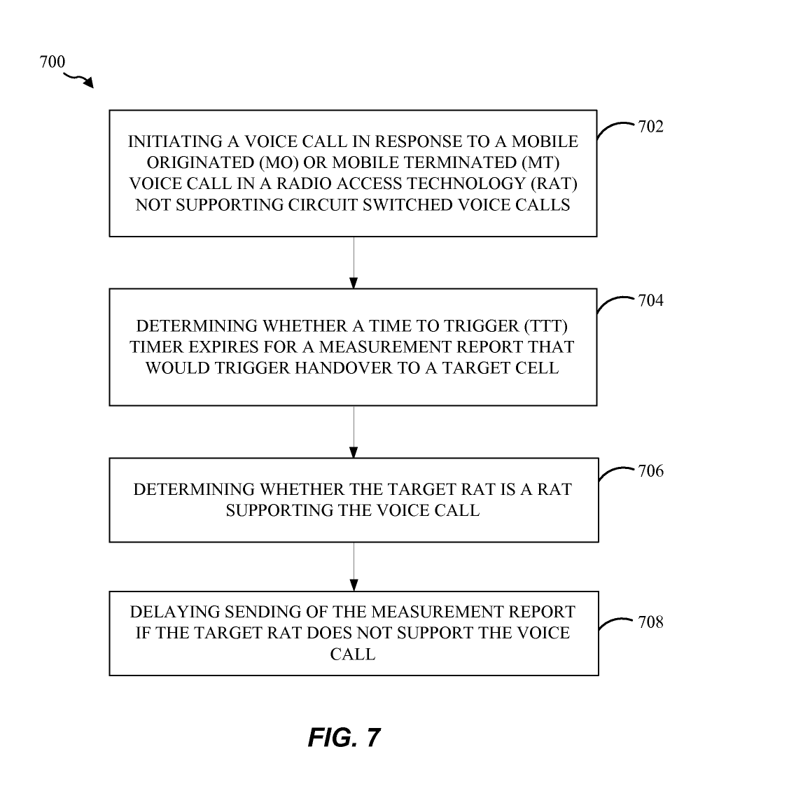

FIG. 7 is a flow diagram illustrating a method 700 for improving measurement reporting for CSFB services at a UE according to aspects of the present disclosure. At block 702, the UE may desire a circuit switched voice call in response to a mobile originated (MO) or mobile terminated (MT) call in a radio access technology (RAT) not supporting the voice call. For example, according to one aspect of the present disclosure, the UE may receive or originate a voice call while camping on an LTE network, which happens to lack support for circuit switched voice calls.

At block 704, the UE determines whether a time to trigger (TTT) timer has expired for a measurement report that would trigger a handover to a target cell. The target cell is selected based on RF conditions experienced by the UE, regardless of the ongoing CSFB procedure.

At block 706, the UE may further determine whether the target cell RAT is of a RAT supporting the voice call. In one aspect of the present disclosure, determining whether the target RAT supports the voice call may include evaluating a CSFB history stored at the UE or/and comparing a network ID of the target cell against a set of network identifiers provisioned at the UE. The network IDs may be received from the system information messages.

At block 708, the UE delays sending the measurement report when the target RAT does not support the voice call, in order to reduce possible delay and save the UE battery power. Whether to delay sending of the measurement report may further be based on a signal quality difference between the serving cell and the target cell and the signal quality of the serving cell. For example, in one aspect of the present disclosure, if the signal quality difference between the serving cell and the target cell is small and the signal quality of the serving cell is good, it is more likely for the UE to delay sending the measurement reports because the need for handover (i.e., sending the measurement reports) may be less urgent. Additionally, the UE may suspend performing one or more inter-frequency, intra-frequency and inter-RAT measurements to further conserve battery power. During the delay, the UE may attempt to establish a connection with another target cell, for example, based on the redirection information provided by the serving cell in a radio resource control (RRC) connection release message, such as the message sent by the LTE network 503 at time 524 of FIG. 5.

According to another aspect of the present disclosure, the UE may send the measurement report to the serving cell without delay when the UE determines the RAT of the target cell supports the voice call. The UE may then initiate a handover to the target cell, after which the CSFB procedure can complete on the target cell.

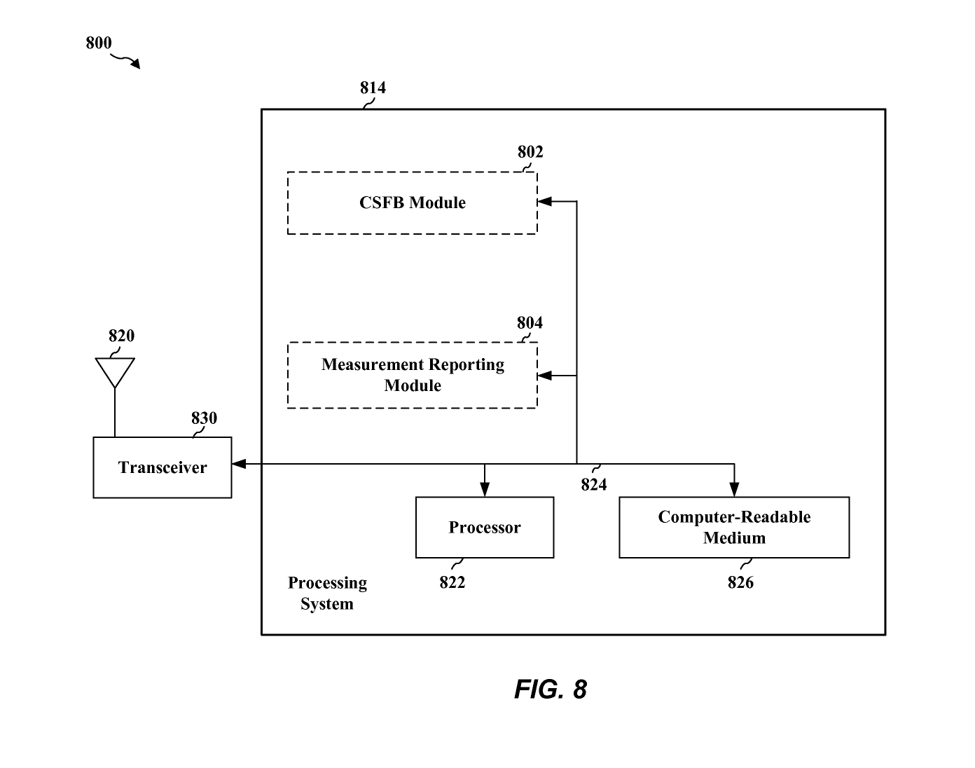

FIG. 8 is a block diagram illustrating an example of a hardware implementation for an apparatus 800 employing a processing system 814 with different modules/means/components for measurement reporting in an example apparatus according to one aspect of the present disclosure. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware modules, represented by the processor 822, the modules 802, 804, and the non-transitory computer-readable medium 826. The bus 824 may also link various other circuits such as timing sources, peripherals, voltage regulators, and power management circuits, which are well known in the art, and therefore, will not be described any further.

The apparatus includes a processing system 814 coupled to a transceiver 830. The transceiver 830 is coupled to one or more antennas 820. The transceiver 830 enables communicating with various other apparatus over a transmission medium. The processing system 814 includes a processor 822 coupled to a non-transitory computer-readable medium 826. The processor 822 is responsible for general processing, including the execution of software stored on the computer-readable medium 826. The software, when executed by the processor 822, causes the processing system 814 to perform the various functions described for any particular apparatus. The computer-readable medium 826 may also be used for storing data that is manipulated by the processor 822 when executing software.

The processing system 814 includes a circuit switched fall back module 802 for initiating a procedure for a CSFB service in response to a mobile originated voice call or mobile terminated voice call in a radio access technology (RAT) not supporting a voice call. The processing system 814 also includes a measurement reporting module 804 for determining whether a time to trigger (TTT) timer has expired for a measurement report configured to trigger a handover to a target cell. The measurement reporting module 804 also can determine whether the target cell is a RAT supporting the CSFB service, and can delaying sending of the measurement report when the RAT of the target cell does not support the CSFB service. The modules 802 and 804 may be software modules running in the processor 822, resident/stored in the computer-readable medium 826, one or more hardware modules coupled to the processor 822, or a combination thereof. The processing system 814 may be a component of the UE 350 of FIG. 3 and may include the memory 392, and/or the controller/processor 390.

In one configuration, an apparatus such as a UE 350 is configured for wireless communication including means for initiating a voice call. In one aspect, the initiating means may be the antennas 352, the receiver 354, the channel processor 394, the receive frame processor 360, the receive processor 370, the transmitter 356, the transmit frame processor 382, the transmit processor 380, the controller/processor 390, the measurement reporting module 391, the memory 392, the measurement reporting module 804, and/or the processing system 814 configured to perform the functions recited by the initiating means.

The UE 350 is also configured to include means for determining whether a time to trigger (TTT) timer expires. In one aspect, the determining means may include the controller/processor 390, the measurement reporting module 391, the memory 392, the measurement reporting module 804, and/or the processing system 814 configured to perform the functions recited by the determining means. In one configuration, the means and functions correspond to the aforementioned structures. In another aspect, the aforementioned means may be a module or any apparatus configured to perform the functions recited by the determining means.

The UE 350 is also configured to include means for determining whether the target cell RAT is a RAT supporting the voice call. In one aspect, the determining means may include the controller/processor 390, the measurement reporting module 391, the memory 392, the measurement reporting module 804, and/or the processing system 814 configured to perform the functions recited by the determining means. In one configuration, the means and functions correspond to the aforementioned structures. In another aspect, the aforementioned means may be a module or any apparatus configured to perform the functions recited by the determining means.

The UE 350 is further configured to include means for delaying sending of the measurement report when the UE determines that the target cell RAT does not support the voice call. In one aspect, the delaying means may include the controller/processor 390, the measurement reporting module 391, the memory 392, the measurement reporting module 804, and/or the processing system 814 configured to perform the functions recited by the delaying means. In one configuration, the means and functions correspond to the aforementioned structures. In another aspect, the aforementioned means may be a module or any apparatus configured to perform the functions recited by the delaying means.

Several aspects of a telecommunications system has been presented with reference to LTE or LTE-advanced (LTE-A) (in FDD, TDD, or both modes), and 2G/3G RATs such as GSM, TD-SCDMA and CDMA2000, and evolution-data optimized (EV-DO). As those skilled in the art will readily appreciate, various aspects described throughout this disclosure may be extended to other telecommunication systems, network architectures and communication standards. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

It is also to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication at a user equipment (UE), comprising:
initiating a procedure for a circuit switched fall back (CSFB) service in response to a mobile originated voice call or a mobile terminated voice call in a radio access technology (RAT) not supporting circuit switched voice calls;
determining whether a time to trigger (TTT) timer has expired for a measurement report configured to trigger a handover to a target cell;
determining whether the target cell is of a RAT supporting circuit-switched voice calls; and
delaying sending of the measurement report when the RAT of the target cell does not support circuit-switched voice calls.

2. The method of claim 1, further comprising suspending an inter-frequency measurement, an intra-frequency measurement, an inter-RAT measurement, or a combination thereof, after initiating the procedure for the CSFB service when a signal quality of a serving cell is above a threshold and the RAT of the target cell does not support circuit-switched voice calls.

3. The method of claim 2, in which delaying sending of the measurement report comprises determining whether to delay reporting of the inter-frequency measurement, the inter-frequency measurement, the inter-RAT measurement, or a combination thereof, based at least in part on a signal quality difference between the serving cell and the target cell and on the signal quality of the serving cell.

4. The method of claim 1, further comprising sending the measurement report without delay when the RAT of the target cell supports circuit-switched voice calls.

5. The method of claim 4, further comprising initiating the handover to the target cell when the RAT of the target cell supports circuit-switched voice calls.

6. The method of claim 1, in which determining whether the target cell is of the RAT supporting circuit-switched voice calls comprises evaluating a CSFB history at the UE and/or a network ID obtained from system information messages.

7. An apparatus for wireless communication, comprising:
a memory; and
at least one processor coupled to the memory and configured:
to initiate a procedure for a circuit switched fall back (CSFB) service in response to a mobile originated voice call or a mobile terminated voice call in a radio access technology (RAT) not supporting circuit switched voice calls;
to determine whether a time to trigger (TTT) timer has expired for a measurement report configured to trigger a handover to a target cell;
to determine whether the target cell is of a RAT supporting circuit-switched voice calls; and
to delay sending of the measurement report when the RAT of the target cell does not support circuit-switched voice calls.

8. The apparatus of claim 7, in which the at least one processor is further configured to suspend an inter-frequency measurement, an intra-frequency measurement, an inter-RAT measurement, or a combination thereof, after initiating the procedure for the CSFB service when a signal quality of a serving cell is above a threshold and the RAT of the target cell does not support circuit-switched voice calls.

9. The apparatus of claim 8, in which the at least one processor is further configured to delay sending of the measurement report by determining whether to delay reporting of the inter-frequency measurement, the inter-frequency measurement, the inter-RAT measurement, or a combination thereof, based at least in part on a signal quality difference between the serving cell and the target cell and on the signal quality of the serving cell.

10. The apparatus of claim 7, in which the at least one processor is further configured to send the measurement report without delay when the RAT of the target cell supports circuit-switched voice calls.

11. The apparatus of claim 10, in which the at least one processor is further configured to initiate the handover to the target cell when the RAT of the target cell supports circuit-switched voice calls.

12. The apparatus of claim 7, in which the at least one processor is further configured to determine whether the target cell is of the RAT supporting circuit-switched voice calls by evaluating a CSFB history at a user equipment (UE) and/or a network ID obtained from system information messages.

13. An apparatus for wireless communication, comprising:
means for initiating a procedure for a circuit switched fall back (CSFB) service in response to a mobile originated voice call or a mobile terminated voice call in a radio access technology (RAT) not supporting circuit switched voice calls;
means for determining whether a time to trigger (TTT) timer has expired for a measurement report configured to trigger a handover to a target cell;
means for determining whether the target cell is of a RAT supporting circuit-switched voice calls; and
means for delaying sending of the measurement report when the RAT of the target cell does not support circuit-switched voice calls.

14. The apparatus of claim 13, further comprising means for suspending an inter-frequency measurement, an intra-frequency measurement, an inter-RAT measurement, or a combination thereof, after initiating the procedure for the CSFB service when a signal quality of a serving cell is above a threshold and the RAT of the target cell does not support circuit-switched voice calls.

15. The apparatus of claim 14, in which the means for delaying sending of the measurement report comprises determining whether to delay reporting of the inter-frequency measurement, the inter-frequency measurement, the inter-RAT measurement, or a combination thereof, based at least in part on a signal quality difference between the serving cell and the target cell and on the signal quality of the serving cell.

16. The apparatus of claim 13, further comprising means for sending the measurement report without delay when the RAT of the target cell supports circuit-switched voice calls.

17. The apparatus of claim 16, further comprising means for initiating the handover to the target cell when the RAT of the target cell supports circuit-switched voice calls.

18. The apparatus of claim 13, in which the means for determining whether the target cell is of the RAT supporting circuit-switched voice calls comprises evaluating a CSFB history at a user equipment (UE) and/or a network ID obtained from system information messages.

19. A computer program product for wireless communication, comprising:
a non-transitory computer readable medium having encoded thereon program code, the program code comprising:
program code to initiate a procedure for a circuit switched fall back (CSFB) service in response to a mobile originated voice call or a mobile terminated voice call in a radio access technology (RAT) not supporting circuit switched voice calls;
program code to determine whether a time to trigger (TTT) timer has expired for a measurement report configured to trigger a handover to a target cell;
program code to determine whether the target cell is of a RAT supporting circuit-switched voice calls; and
program code to delay sending of the measurement report when the RAT of the target cell does not support circuit-switched voice calls.

20. The computer program product of claim 19, further comprising program code to suspend an inter-frequency measurement, an intra-frequency measurement, an inter-RAT measurement, or a combination thereof, after initiating the procedure for the CSFB service when a signal quality of a serving cell is above a threshold and the RAT of the target cell does not support circuit-switched voice calls.

21. The computer program product of claim 20, in which the program code to delay sending of the measurement report determines whether to delay reporting of the inter-frequency measurement, the inter-frequency measurement, the inter-RAT measurement, or a combination thereof, based at least in part on a signal quality difference between the serving cell and the target cell and on the signal quality of the serving cell.

22. The computer program product of claim 19, further comprising program code to send the measurement report without delay when the RAT of the target cell supports circuit-switched voice calls.

23. The computer program product of claim 22, further comprising program code to initiate the handover to the target cell when the RAT of the target cell supports circuit-switched voice calls.

24. The computer program product of claim 19, in which the program code to determine whether the target cell is of the RAT supporting circuit-switched voice calls evaluates a CSFB history at a user equipment (UE) and/or a network ID obtained from system information messages.
